(19) United States
(12) Patent Application Publication
(10) Pub. No.: US 2009/0090207 A1
(43) Pub. Date: Apr. 9, 2009

(54) External Circulation Type Ball Screw

(76) Inventors: Horng Ruey CHANG, Taichung (TW); Yueh-Ling CHIU, Taichung (TW); Wen-Tun LIN, Taichung (TW)

Correspondence Address: Dr. BANGER SHIA, 102 Lindencrest Ct., Sugar Land, TX, 77479-5201, US

(21) Appl. No.: 11/868,510

(22) Filed: Oct. 7, 2007

(51) Int. Cl. F16H 25/22; F16H 55/02

(52) U.S. Cl. 74/424.86

(57) ABSTRACT

An external circulation type ball screw is provided with a helical passage in the outer surface of the nut. The helical passage and the inner helical groove of the nut are opposite in winding direction to each other. The nut is defined with two through holes which are connected to both ends of the inner helical groove and the helical passage, respectively, so that the helical passage and the inner helical groove are connected to each other to form a circulating path for the circulation of the balls. Since the helical passage winds about the outer periphery of the nut, the balls can roll more smoothly.

### BACKGROUND OF THE INVENTION

1. Field of the Invention

The present invention relates to a ball screw, and more particularly to an external circulation type ball screw with a helical passage formed in the outer surface of the nut.

2. Description of the Prior Art

Ball screw utilizes its rolling balls to reduce the friction between the screw and the nut, so it has the advantages of high precision and low kinetic energy consumption. The current development emphasis of the ball screw is placed on the circulation methods of the balls, and there are various circulation methods, for instance, the both ends of helical groove of the nut are directly connected by a pipe, or the nut is provided with cassettes and return passage, or the helical groove of the nut are connected by cassette to form a closed path, or outside the nut is provided with a passage for circulation of the balls.

However, with the above various designs, for example, both ends of helical groove of the nut being connected with a pipe, or the nut with cassettes and return path, when the balls move in and out of the pipe or the return passage, the turning angle of the ball rolling path is almost 90 degrees, which causes the unsmooth rolling motion of the balls. As for the design that the helical groove of the nut is connected to form a closed path, the manufacturing and assembling error of the cassette will produce height different between the cassette and the threads of the nut, causing the unsmooth motion of the balls. Furthermore, using the cassette to make the balls roll a short distance to the neighboring thread and then return, the balls must climb over the tip of a thread of the screw, and this will affect the smoothness of the rolling motion of the balls.

The method of arranging the passage outside the nut is as disclosed in U.S. Pat. No. 5,142,929 (as shown in FIG. 1) and U.S. Pat. No. 6,041,672 (as shown in FIG. 2), wherein a passage A2 (not shown in FIG. 1) is provided outside the nut A for connecting the inner helical groove A1, and at each end of the passage A2 are disposed a guiding assembly C for guiding the circulation of the balls B from the inner helical groove A1 into the passage A2 or from the passage A2 into the inner helical groove A1. FIG. 3 shows that the guiding assembly C of U.S. Pat. No. 6,041,672 guides the circulation of balls B between the nut A and the screw D.

However, the guiding assembly C of these two ball screws for guiding the balls B has a serious problem, that is when the balls B circulate between the inner helical groove A1 of the nut A and the passage A2, only with the forcible guidance of the guiding assembly C, the balls B can change their rolling direction and keep circulating. However, the external force applied by the guiding assembly C will cause unsmooth circulation of the balls, or even worse, the balls B will impact the guiding assembly C, thus reducing the service life of the guiding assembly C and increasing the maintenance fee.

It is apparent that all the above various circulation methods (including the both ends of helical groove of the nut being directly connected by a pipe, or the nut\with cassettes and return passage, or the helical groove of the nut being connected by cassette to form a closed path, or outside the nut being provided with a passage for circulation of the balls) are unable to solve the unsmooth circulation of the balls. In addition, the abovementioned first two conventional ball screws must use guiding members to guide the circulation of the balls. Besides the problem of unsmooth circulation, the guiding members are likely to impact the balls and cause damage.

The present invention has arisen to mitigate and/or obviate the afore-described disadvantages.

### SUMMARY OF THE INVENTION

The primary objective of the present invention is to provide an external circulation type ball screw for enabling the balls to roll more smoothly and reducing the turning angle when the balls are circulating.

To achieve the above objective, a helical passage is formed in the outer surface of the nut of the external circulation type ball screw, the helical passage and the inner helical groove are opposite in winding direction to each other and are connected to each other to form a circulating path in which the balls are to roll and circulate.

When the balls roll from the inner helical groove 21 into the helical path 22 or from the helical path into the inner helical groove, since the inner helical groove and the helical path are opposite in winding direction to each other, the balls roll in the same winding direction, and the rolling direction and angle of the balls are almost not changed, as a result, the turning angle of the ball rolling path is very small. Hence, the balls can roll more smoothly. Furthermore, the helical passage can take the form of a thread which corresponds to the winding of the inner helical groove. The nut is defined with two through holes which are connected to both ends of the inner helical groove and the helical passage, respectively, so that the helical passage and the inner helical groove are connected to each other to form a circulating path.

In addition, the helical passage can take the form of a helical groove, and a housing is mounted outside the nut for restricting the balls within the helical passage.

### BRIEF DESCRIPTION OF THE DRAWINGS

FIG. 1 is a perspective view of a conventional ball screw with a passage formed in the outer surface of the nut;

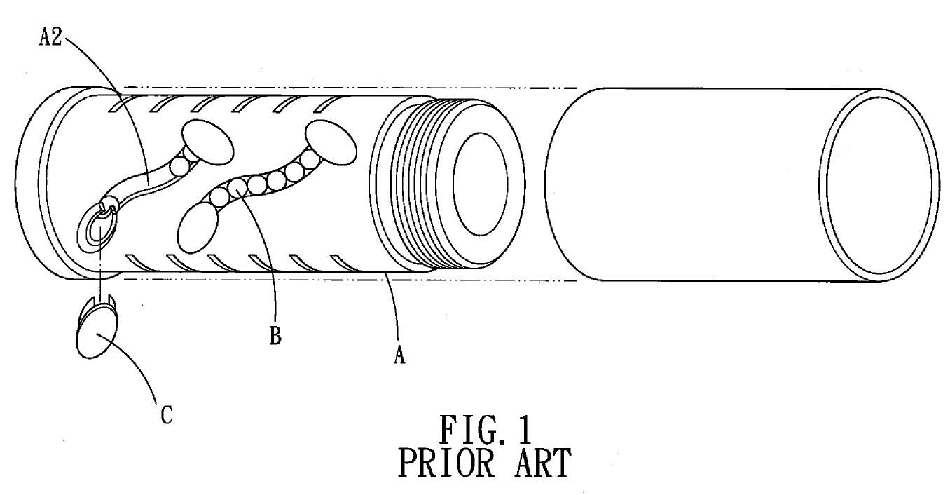

FIG. 2 is a perspective view of another conventional ball screw with a passage formed in the outer surface of the nut;

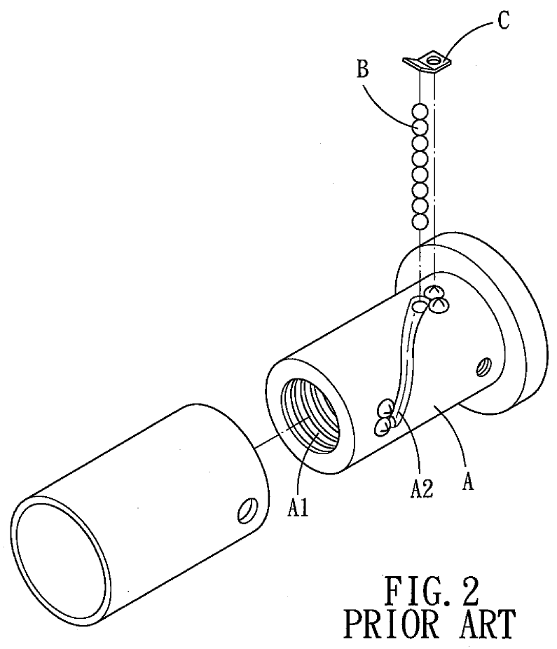

FIG. 3 shows the circulation of the balls guided by the guiding assembly of FIG. 2;

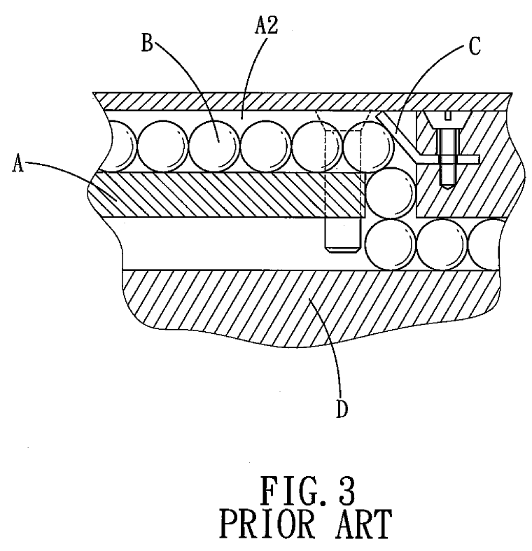

FIG. 4 is a cross sectional assembly view in accordance with the present invention of showing the screw, the nut, the balls and the housing;

FIG. 5 is a perspective view of a nut in accordance with the present invention;

FIG. 6 is a side view of the nut in accordance with the present invention;

FIG. 7 is an assembly view of the nut and the housing in accordance with the present invention;

FIG. 8 is a perspective view of showing the circulation of the balls in accordance with the present invention; and

FIG. 9 is a perspective view in accordance with the present invention of showing that the balls are restricted by the housing in the helical passage.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

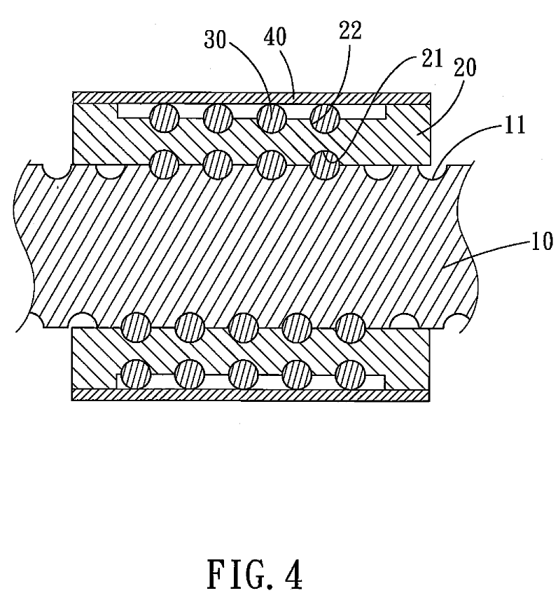

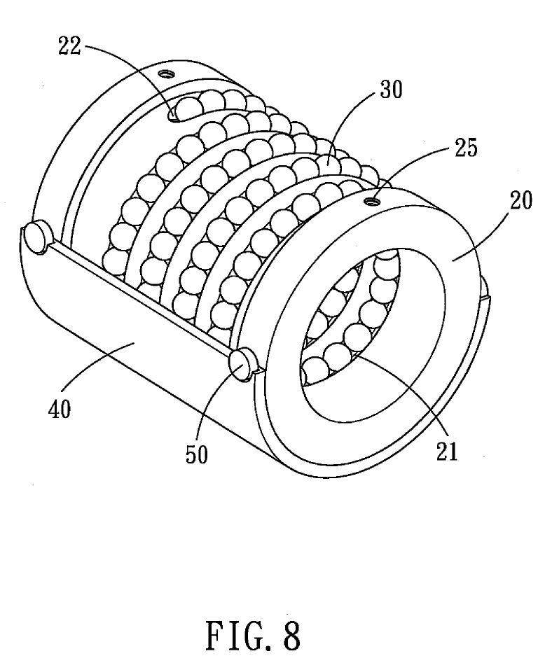

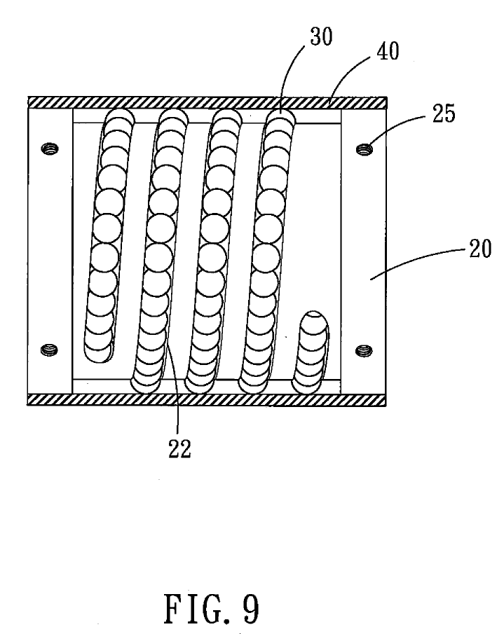

Referring to FIGS. 4-9, an external circulation type ball screw in accordance with the present invention comprises: a screw 10, a nut 20, a plurality of balls 30, and a housing 40.

The screw 10 is provided on its outer surface with a helical groove 11.

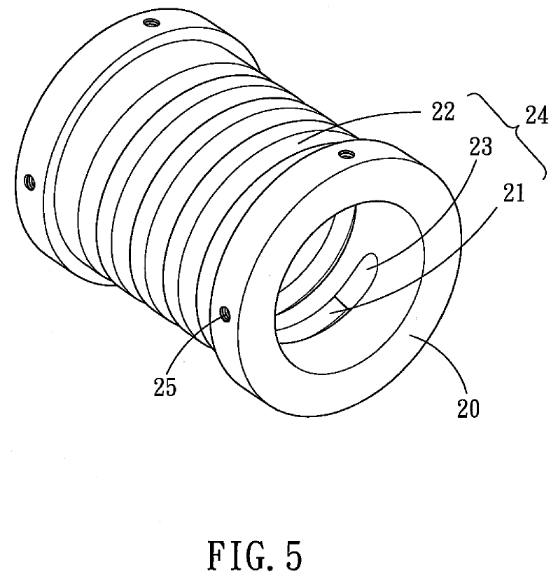

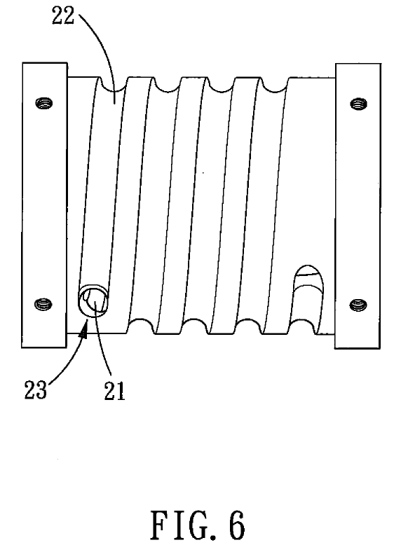

The nut 20 is screwed on the screw 10 and is provided on its inner and outer surfaces with an inner helical groove 21 and a helical passage 22 in the form of a helical groove or a thread, respectively, as shown in FIGS. 5 and 6. The inner helical groove 21 is Gothic type in cross section, the helical passage 22 is arc-shaped in cross section, and the inner helical groove 21 corresponds to the helical groove 11 of the screw 10. The helical passage 22 winds at least a full revolution about the outer periphery of the nut 20. The helical passage 22 and the inner helical groove 21 are compatible in size, but their winding directions are opposite. The nut 20 is defined with two through holes 23 which are connected to both ends of the inner helical groove 21 and the helical passage 22, respectively. The inner helical groove 21, the helical passage 22 and the two through holes 23 define a circulating path 24.

The balls 30 circulate within d the circulating path 24 of the nut 20.

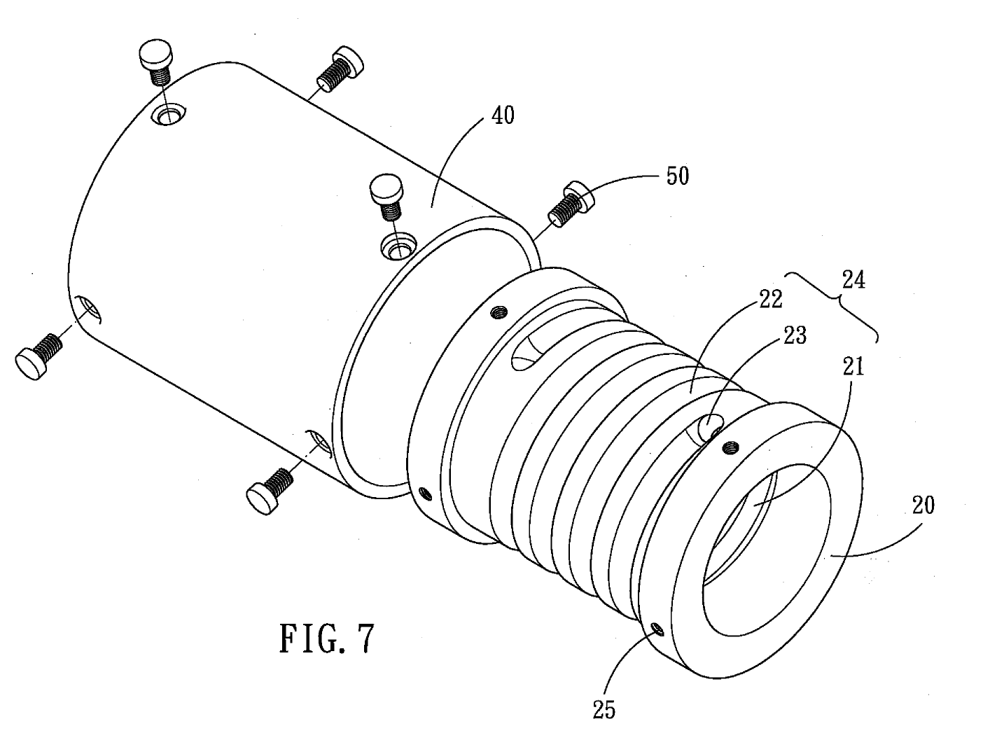

The housing 40, as shown in FIG. 7, is mounted outside the nut 20. In the outer surface of the nut 20 are formed a plurality of threaded holes 25 through which the housing 40 is screwed on the nut 20 by screws 50.

The circulation of the balls 30 is shown in FIGS. 4, 8 and 9, when rolling in the inner helical groove 21 of the circulating path 24 of the nut 20, the balls 30 meanwhile are also rolling in the helical groove 11 of the screw 10. And when rolling in the helical path 22 of the circulating path 24 of the nut 20, the balls 30 can be prevented from falling off the circulating path 24 by the housing 40.

The balls 30 roll between the inner helical groove 21 of the nut 20 and the helical groove 11 of the screw 10, when the balls 30 roll from the inner helical groove 21 of the nut 20 into the helical path 22 via the through hole 23, since the inner helical groove 21 and the helical path 22 are opposite in winding direction to each other, the inner helical groove 21 is connected to the helical path 22 in a straight line via the through hole 23. Therefore, the balls 30 can roll smoothly from the inner helical groove 21 into the helical path 22.

And vice versa, when rolling from the helical path 22 into the inner helical groove 21 of the nut 20 via the through hole 23, the balls 30 can also smoothly roll from the helical path 22 into the inner helical groove 21.

It is apparent from the aforementioned description that when the balls 30 roll within the circulating path 24 of the nut 20, no matter the balls 30 move from the inner helical groove 21 into the helical path 22 or from the helical path 22 into the inner helical groove 21, since the inner helical groove 21 and the helical path 22 are opposite in winding direction to each other and the inner helical groove 21 is connected to the helical path 22 is connected to the inner helical groove 21 in a straight line via the through hole 23, the balls 30 roll in the same winding direction, and the rolling direction and angle of the balls 30 are almost not changed. As compared with the prior art of using the guiding assembly C to forcibly change the rolling direction of the balls B, the present invention can make the balls 30 roll more smoothly. Furthermore, since it requires no extra guiding assembly, the number of components and assembly time of the present invention will be reduced, and as a result, the production cost can also be saved.

While we have shown and described various embodiments in accordance with the present invention, it is clear to those skilled in the art that further embodiments may be made without departing from the scope of the present invention.

What is claimed is:

1. An external circulation type ball screw, comprising:
a screw provided on its outer surface with a helical groove;
a nut being screwed on the screw and provided on its inner surface with an inner helical groove corresponding to the helical groove of the screw and provided on its outer surface with a helical passage, the helical passage winding at least a fall revolution about outer periphery of the nut, the helical passage and the inner helical groove being opposite in winding direction to each other and being connected to each other to form a circulating path; and
a plurality of balls disposed in the circulating path of the nut.

2. The external circulation type ball screw as claimed in claim 1, wherein the helical passage is arc-shaped.

3. The external circulation type ball screw as claimed in claim 1, wherein the inner helical groove of the nut is Gothic type in cross section.

4. The external circulation type ball screw as claimed in claim 1, wherein the nut is defined with two through holes which are connected to the inner helical groove and the helical passage, respectively.

5. The external circulation type ball screw as claimed in claim 4, wherein the two through holes of the nut are connected to both ends of the inner helical groove and the helical passage, respectively

6. The external circulation type ball screw as claimed in claim 1, wherein a housing is mounted outside the nut for restricting the balls within the helical passage.

7. The external circulation type ball screw as claimed in claim 6, wherein, in an outer surface of the nut are formed a plurality of threaded holes through which the housing is screwed on the nut by screws.
